(19) United States
(12) Patent Application Publication
(10) Pub. No.: US 2017/0107717 A1
(43) Pub. Date: Apr. 20, 2017

(54) BUILDING MATERIAL FOR DOORS AND WINDOWS, AND METHOD OF MAKING THE SAME

(71) Applicant: NIEN MADE ENTERPRISE CO., LTD., Taichung City (TW)

(72) Inventor: Keng-Hao NIEN, Taichung (TW)

(21) Appl. No.: 15/009,535

(22) Filed: Jan. 28, 2016

(30) Foreign Application Priority Data
Oct. 14, 2015 (CN) 201520792839.3

(51) Int. Cl. E04C 2/28; B29C 65/48

(52) U.S. Cl. CPC E04C 2/28; B29C 65/48; B29L 2031/10

(57) ABSTRACT

A building material for doors and windows and a method of making the building material are disclosed. The building material includes, from inside to outside, a core, a piece of reinforced material, a panel, and a cover film, wherein a surface of the core is applied with an adhesive material. The piece of reinforced material includes a piece of carbon fiber fabric, wherein the adhesive material penetrates the pieces of carbon fiber fabric. The adhesive material fixes the panel and the core after it is dried, and makes the piece of carbon fiber fabric locate between the panel and the core. Whereby, the building material has significant improvement in the aspect of anti-bending because the piece of carbon fiber fabric has reinforcing functions such as pull resistance, shear resistance, and shock resistance.

The current application claims a foreign priority to application number 201520792839.3 filed on Oct. 14, 2015 in China.

### BACKGROUND OF THE INVENTION

1. Technical Field

The present invention relates generally to building materials of doors and windows, and more particularly to a building material of doors and windows, which is rigid and lightweight, and a method of making the building material.

2. Description of Related Art

Conventionally, frames of doors and windows are mostly made of building materials such as extruded aluminum or lumber; the former has a rigid texture, and the latter looks natural and plain, each has its fans. However, though extruded aluminum is firm and withstanding, it is not lightweight enough. On the other hand, though lumber is lightweight, it is somewhat not firm enough, and may get damp or eaten by worms. Therefore, it would be a dilemma if we had to choose between these two building materials for doors and windows.

Even if some building materials have advantages of the aforementioned extruded aluminum and lumber at the same time, they are usually expensive for containing raw materials of high price, or for having complicated manufacturing procedures. For any consumer, the tag price of a product would directly affect the willingness to pay, but it would not be easy to lower the tag price of such building materials due to the raw materials of high price or the complicated manufacturing process, which both increase the manufacturing cost.

Take a Venetian door for example, which is generally made of log or composite lumber nowadays. While installing such a Venetian door, a side of a sash of the Venetian door is pivotally mounted to a frame, and an opposite side thereof can be pivoted around a pivoting axis, i.e., the frame. In order to temporarily fix the pivotable free side onto the frame when the sash is closed, it is common to correspondingly provide several pairs of magnets at the free side of the sash and the frame, whereby the sash would not randomly swing when being closed. However, in practice, it would be difficult to separate or connect each pair of magnets precisely at the same time. As a result, the sash would be wobbling for being pulled in an uneven way, and a user may experience an unsmooth operation. Furthermore, after a long period of use, the sash tends to be deformed due to the uneven pulling force. In addition to having an unfavorable appearance, a deformed sash would not be able to provide a smooth operational experience, and the components thereof would not perfectly match each other as originally designed. In the end, the function of shielding light would be compromised.

Moreover, for those Venetian doors installed on ceilings, their sashes may be tilted or parallel relative to the ground. Thanks to the gravity, such a sash would greatly endure a downward force, and, therefore it tends to be bent or deformed since the components thereof may not have sufficient rigidity. If the sash is made of lumber, the problem is likely to be even worse with the effect of sun exposure, weather, or humidity. In other words, the conventional building materials for doors and windows still have room for improvement in the aspect of anti-bending ability.

### BRIEF SUMMARY OF THE INVENTION

In view of the above, the primary objective of the present invention is to provide a building material for doors and windows, and a method of making the building material, wherein the material is lightweight, and the anti-bending ability thereof is further improved.

The present invention provides a building material for doors and windows, which includes, from inside to outside, a core, a piece of reinforced material, a panel, and a cover film. The building material is characterized in that, a surface of the core is applied with a first adhesive material; a surface of the panel corresponding to the piece of the reinforced material is applied with a second adhesive material; the piece of reinforced material comprises a piece of carbon fiber fabric; the panel and the core are fixed by the first adhesive material and the second adhesive material, wherein the piece of carbon fiber fabric is located between the panel and the core, and the cover film at least covers a surface of the panel along a long axis thereof.

The present invention further provides a method of making a building material for doors and windows, which includes the following steps: provide a core, at least one piece of carbon fiber fabric, and at least one panel; apply an adhesive material on the core and the at least one panel; assemble the core, the at least one piece of carbon fiber fabric, and the at least one panel, wherein each of the at least one piece of carbon fiber fabric is located between one of the at least one panel and the core, and the at least one panel and the core are firmly combined by the adhesive material; cover a plastic film on a surface of the at least one panel by extrusion.

Whereby, the anti-bending ability of the building material can be improved.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a blind using a building material of a preferred embodiment of the present invention;

FIG. 2 is a flow chart of making the building material;

FIG. 3 is a perspective view, showing an upright which is cut and separated from the building material;

FIG. 4 is an exploded view of the upright in FIG. 3;

FIG. 5 is a perspective view, showing a plate which is cut and separated from the building material;

FIG. 6 is an exploded view of the plate in FIG. 5;

FIG. 7 is a perspective view, showing a slat which is cut and separated from the building material; and

FIG. 8 is an exploded view of the slat in FIG. 7.

### DETAILED DESCRIPTION OF THE INVENTION

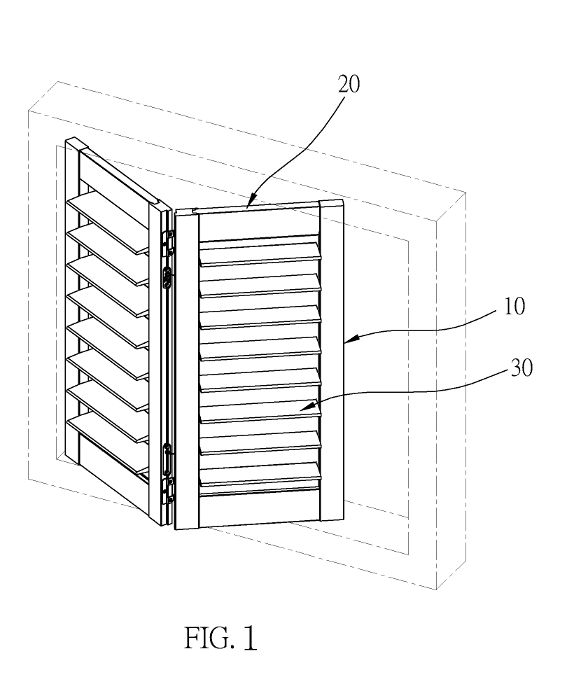

As shown in FIG. 1, a window blind made of a building material for doors and windows of a preferred embodiment of the present invention includes two sashes, each of which is composed of two uprights 10, two plates 20, and a plurality of slats 30, wherein the plates 20 are provided between the uprights 10, and are respectively located at a top edge and a bottom edge of the uprights 10; the slats 30 are arranged in parallel in a space surrounded by the uprights 10 and the plates 20, and the slats 30 are adapted to be turned.

A structure of the building material for doors and windows of the first preferred embodiment of the present invention mainly includes, from inside to outside, a core, a piece of reinforced material, a panel, and a cover film. The number of each of the aforementioned components can be adjusted in order to meet different requirements. The building material where each of the uprights 10 is separated from is described below first, and the building materials where each of the plates 20 and each of the slats 30 are separated from are explained later.

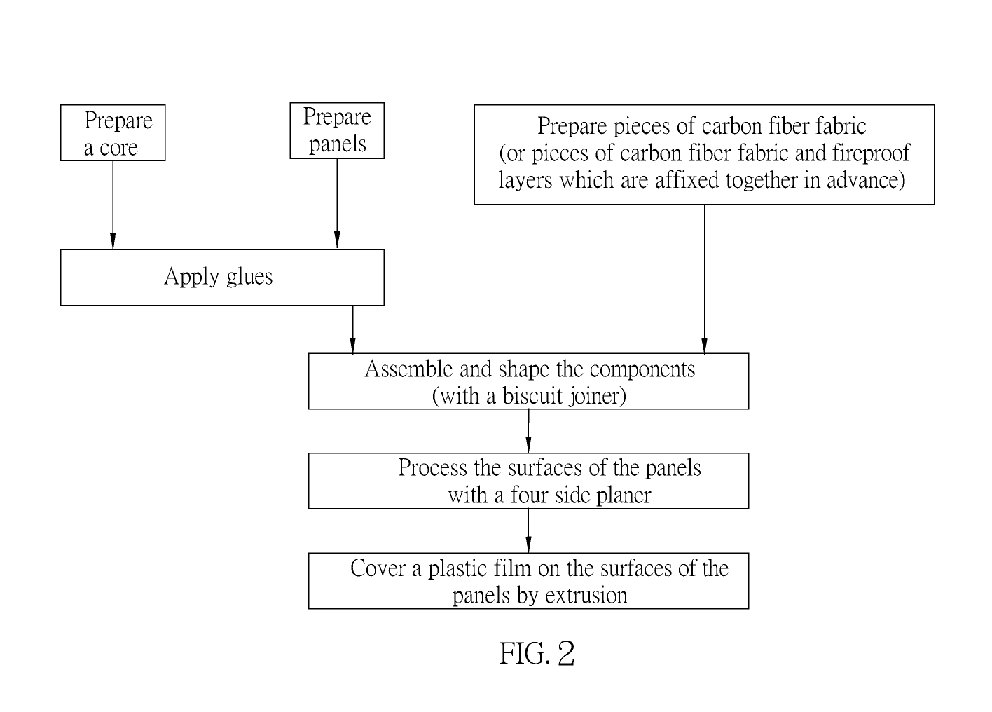

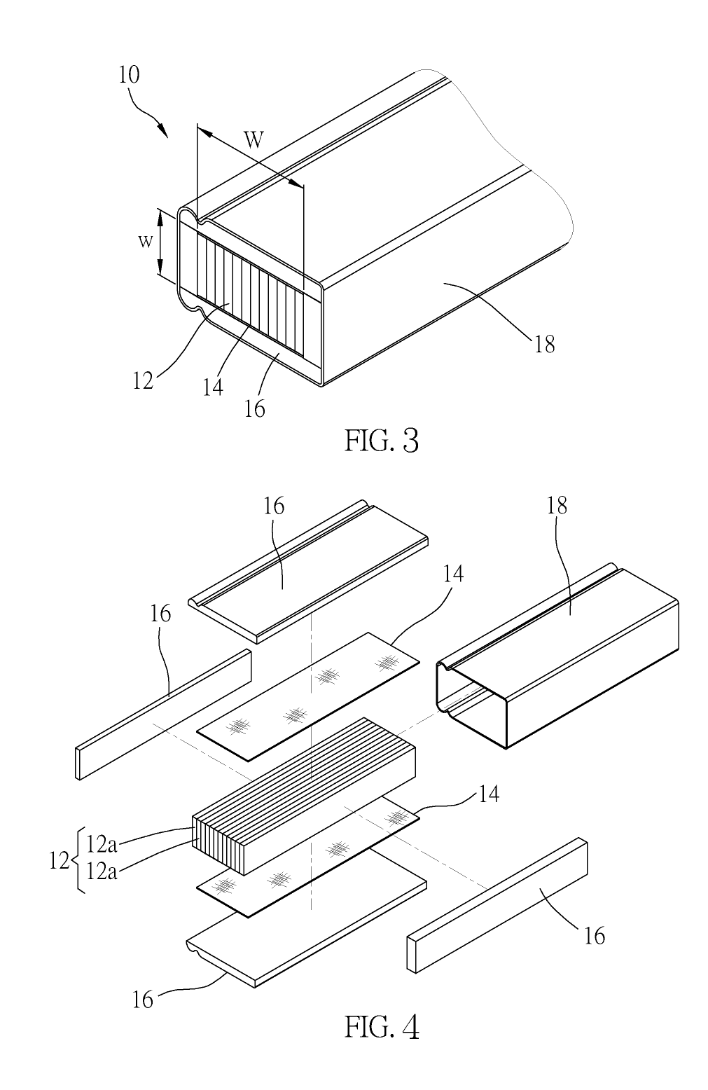

The building material of the present invention for making each of the uprights 10 is illustrated in FIG. 3 and FIG. 4, which includes a core 12, two pieces of reinforced material 14, four panels 16, and a cover film 18. In other words, the building material has the same composition with each of the uprights 10. A flowchart of making the building material is shown in FIG. 2. The core 12 could be selected from the group consisting of fiberboard, wood core panel, finger joint laminated board, or laminated veneer lumber (LVL). Since the core 12 is the main structure of each of the uprights 10, the core 12 of the preferred embodiment is made of a plurality of pieces of laminated veneer lumber 12a which are arranged in parallel. More specifically, each of the pieces of laminated veneer lumber 12a abuts against a wide surface of the neighboring piece of laminated veneer lumber 12a with a wide surface thereof. The resulted core 12 has four side surfaces, which can be divided into two sets of two corresponding side surfaces. A width W of the core 12 in a direction of arranging the pieces of laminated veneer lumber 12a is greater than a width w in another vertical direction, wherein said two widths W and w belong to an end surface of the core 12. With such limitation of widths, the rigidity and the anti-bending ability of the structure are enhanced.

During the manufacturing process of the building material, the core 12, the pieces of reinforced material 14, and the panels 16 are prepared into required sizes in advance, wherein the pieces of reinforced material 14 of the preferred embodiment are pieces of carbon fiber fabric as an example. After that, the four side surfaces of the core 12 are applied with a first adhesive material, which is epoxy as an example; at the same time, surfaces of the panels 16 which face the pieces of reinforced material 14 are applied with a second adhesive material, which is commercially available lamination adhesive material as an example. Each of the pieces of reinforced material 14 is then respectively attached to one of the two wider side surfaces of the core 12, wherein the first adhesive material penetrates the pieces of carbon fiber fabric to affix the pieces of carbon fiber fabric on the core 12; meanwhile, the panels 16 are pressed to abut against four side surfaces constructed by the core 12 and the pieces of reinforced material 14. Once the first adhesive material and the second adhesive material are heated and dried, the four panels 16 are firmly affixed on the four side surfaces composed by the core 12 and the pieces of reinforced material 14, wherein two of the pieces of reinforced material 14 are respectively located between one of the panels 16 and the core 12 on one of the wider side surfaces. Procedures of assembling and shaping the building material are completed at this time. The aforementioned procedures are completed with a biscuit joiner.

The panels 16 are selected from fiberboards, wherein fiberboards can be classified into three major types by density, including insulation density fiberboard (IDF), middle density fiberboard (MDF), and high density fiberboard (HDF). In the preferred embodiment of the present invention, the panels 16 are selected from MDF. Of course, the panels 16 can be also selected from wood core panel, finger joint laminated board, or laminated veneer lumber in practice. However, MDF is still the most preferred material if the manufacturing cost is taken into account.

After completing the assembly of the aforementioned components, the method of making the building materials for doors and windows of the preferred embodiment of the present invention further includes the step of processing the surface of the panels 16, wherein the objective of this step is to create a predetermined shape, pattern, or decorative textures to provide an aesthetic result. The method of processing the surface of the panels 16 includes but not limited to milling, cutting, planning, and trimming, and there can be more than one of the panels 16 to be processed. In the preferred embodiment, a four side planer is used to process the surface of each of the four panels 16 at the same time to create an impression of depth and solidity. However, if each of the panels 16 is processed in advance before assembling the building material, this step of processing the surface of the panels 16 can be omitted. In addition, if it is required to create a plain and natural impression, the step can be omitted as well to keep the panels 16 the way they are.

After processing the surface of the panels 16, by using an extruder, a plastic film covers the surface of the panels 16 of the semi-finished building material, wherein the plastic film is evenly affixed on the surface of the panels 16, and becomes the cover film 18 of the preferred embodiment after being dried. The cover film 18 could protect the panels 16 which are mainly made of lumber, and could make the building material have a moisture-proof function and have the ability to prevent infestation. It is worth mentioning that, the aforementioned plastic film can be made of melted polypropylene (PP) plastic pellets. Therefore, by using plastic pellets with colors, the resulted cover film 18 can have a predetermined color to create a certain texture for the building material, which makes the uprights 10 cut and separated from the building material more commercially competitive.

Take a 20-centimeter (8 inches) long, 5-centimenter wide, and 2.5-centimeter high elongated building material for example, wherein the aforementioned building material, which has the pieces of reinforced material 14 provided therein and is adapted to be cut into the uprights 10, is used as a test group, while another building material, which has the same conditions but has no pieces of reinforced material 14, is used as a control group. It is proven that, when these two building materials are placed with a wider surface thereof in parallel to the ground, and an end thereof along a long axis is fixed, while another opposite end thereof is suspended, the suspended end of the building material in the control group (i.e., the one has no pieces of reinforced material 14) is lower than the suspended end of the building material in the test group (i.e., the one has pieces of reinforced material 14 provided therein) by 6mm-8mm due to the effect of gravity. In other words, the building material in the control group has worse anti-bending ability than the building material in the test group.

It has been proven in the aforementioned experiment that, thanks to the carbon fiber fabric provided on both wider side surfaces, the bending condition of the building material in the test group is significant minor than that of the building material in the control group, which is because each of the pieces of the carbon fiber fabric has reinforcing functions such as pull resistance, shear resistance, and shock resistance. In other words, the building material presented in the present invention has improvement in the aspect of anti-bending. As a result, each of the uprights 10 which are cut and separated from the building material has an enhanced rigidity.

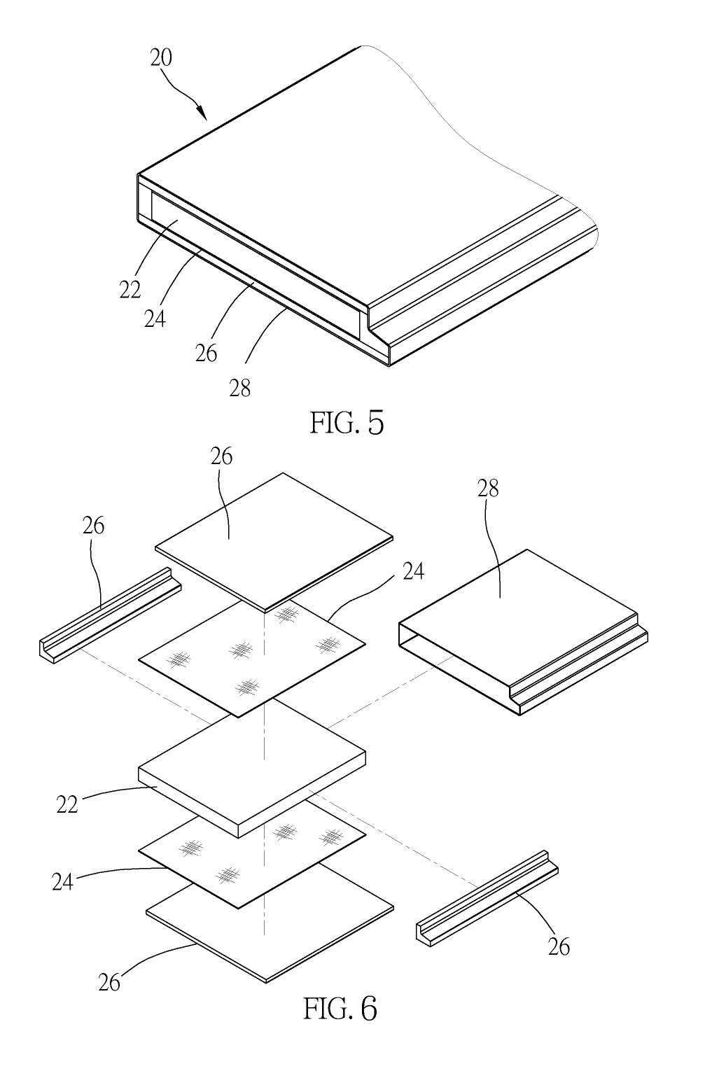

The plates 20 are cut and separated from the building material shown in FIG. 5 and FIG. 6, which also includes a core 22, pieces of reinforced material 24, panels 26, and a cover film 28. The components mentioned here has the same structural relation with the building material illustrated in FIG. 3 and FIG. 4, and are made by the same method; therefore, we are not going to describe the related details herein. More specifically, the building material shown in FIG. 5 and FIG. 6 is different from the building material shown in FIG. 3 and FIG. 4 only in size and shape. Yet another difference between these two preferred embodiments is that the core 22 in the latter preferred embodiment is selected from a wood core panel, while the core 12 in the prior preferred embodiment is formed by connecting multiple pieces of laminated veneer lumber 12a in parallel.

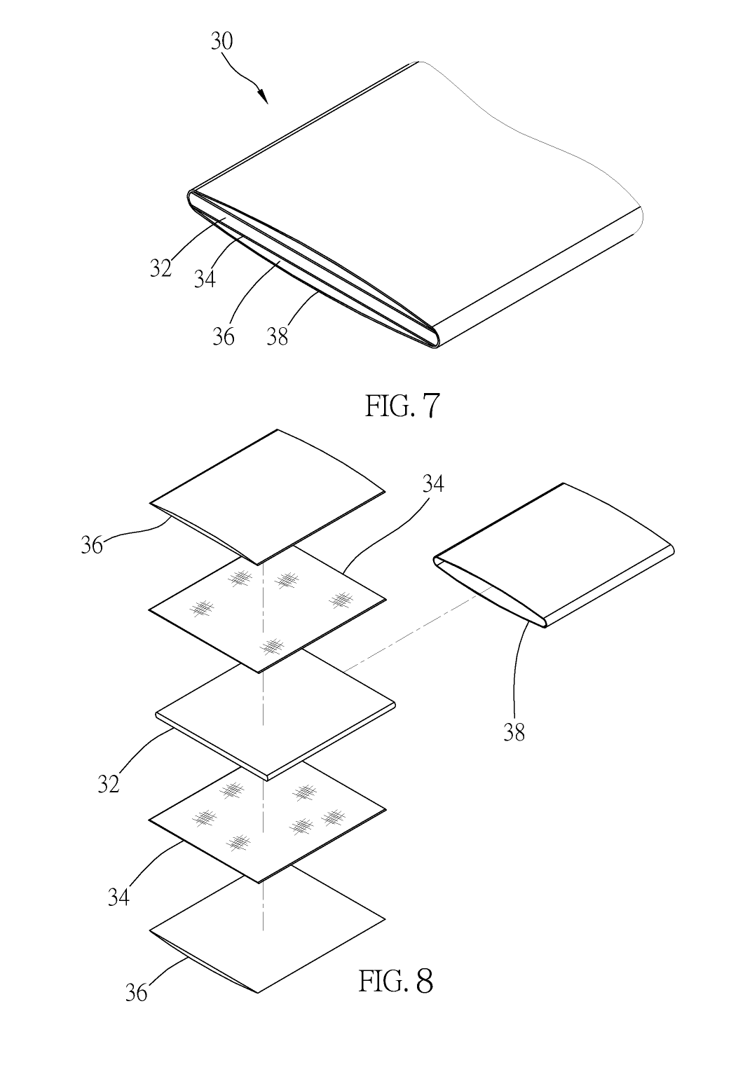

The slat 30 are cut and separated from the building material shown in FIG. 7 and FIG. 8, which also includes a core 32, pieces of reinforced material 34, panels 36, and a cover film 38. Similarly, regardless of different sizes and shapes, the structural relation and the method of making the building material in this preferred embodiment is the same with the building materials of the other two preferred embodiment for making the uprights 10 or the plates 20. Other differences include that the core 32 in this preferred embodiment is made of MDF, and two panels included in other two preferred embodiments are omitted, wherein each of the panels 36 is provided on one of the wide surfaces (i.e., the top surface and the bottom surface) of the core 32, with a piece of reinforced material 34, which is a piece of carbon fiber fabric as an example, disposed therebetween. With such differences, the slats 30 can be light and thin.

No matter each of the building materials presented in the preferred embodiments in the present invention is used for making the uprights 10, the plates 20, or the slats 30, it all has two pieces of reinforced material, which are pieces of carbon fiber fabric as an example, wherein each of the two pieces of reinforced material is affixed on one of the two wider side surfaces (i.e., the top surface and the bottom surface) of the core, and is engaged with the core and one of the panels by adhesive materials. The building materials presented in the preferred embodiments in the present invention all have enhanced anti-bending ability exactly due to the additional pieces of carbon fiber fabric.

It has to be mentioned that, instead of using two pieces of carbon fiber fabric, the building materials of the aforementioned embodiments can also use a single and large piece of carbon fiber fabric to directly cover the whole surface of the core. Alternatively, the pieces of reinforced material in the aforementioned embodiments can further include a fireproof layer (not shown), which can be placed either between the core and one of the pieces of carbon fiber fabric, or between one of the pieces of carbon fiber fabric and one of the panels during the process of assembling the building materials. The fireproof layer mentioned herein is a high-pressure laminate (HPL) composed of paper impregnated with thermosetting resin. With the fireproof layer, the building materials provided in the present invention not only have an enhanced anti-bending ability but also is flame retardant.

In practice, the fireproof layer and one piece of carbon fiber fabric can be combined together with a third adhesive material to form one of the pieces of reinforced material in advance, wherein the third adhesive material can be epoxy. After the third adhesive material is dried and hardened, this piece of compound reinforced material can be cut to required size, and then placed between the core and one of the panels by the aforementioned method. An alternative way to reach the same result is to cut one piece of carbon fiber fabric and the fireproof layer to required size respectively, and apply the third adhesive material therebetween when the first adhesive material and the second adhesive material are applied on the core and the panels during the process of applying adhesive materials. After that, the components are sequentially combined, affixed, or connected together, and are then pressed and dried to get firmly fixed during the process of assembling and shaping.

It must be pointed out that the embodiments described above are only some preferred embodiments of the present invention. All equivalent structures and methods which employ the concepts disclosed in this specification and the appended claims should fall within the scope of the present invention.

What is claimed is:

1. A building material for doors and windows, comprising, from inside to outside, a core, a piece of reinforced material, a panel, and a cover film; the building material is characterized in that:
a surface of the core is applied with a first adhesive material; a surface of the panel corresponding to the piece of the reinforced material is applied with a second adhesive material; the piece of reinforced material comprises a piece of carbon fiber fabric; the panel and the core are fixed by the first adhesive material and the second adhesive material, wherein the piece of carbon fiber fabric is located between the panel and the core, and the cover film at least covers a surface of the panel along a long axis thereof.

2. The building material of claim 1, wherein the core is selected from the group consisting of fiberboard, wood core panel, finger joint laminated board, or laminated veneer lumber.

3. The building material of claim 1, wherein the panel is selected from the group consisting of fiberboard, wood core panel, finger joint laminated board, or laminated veneer lumber.

4. The building material of claim 1, wherein the piece of reinforced material further includes a fireproof layer, which is located either between the core and the piece of carbon fiber fabric, or between the piece of carbon fiber fabric and the panel.

5. The building material of claim 4, wherein the fireproof layer and the piece of the carbon fiber fabric of the piece of reinforced material are combined with a third adhesive material.

6. The building material of claim 4, wherein the fireproof layer is a high-pressure laminate composed of paper impregnated with thermosetting resin.

7. The building material of claim 1, wherein the cover film comprises a plastic film covering the surface of the panel.

8. The building material of claim 1, wherein the core has multiple side surfaces, and at least one of the side surfaces is wider than other of the side surfaces; the piece of carbon fiber fabric is affixed on the wider side surface of the core.

9. A method of making a building material, comprising the steps of:
providing a core, at least one piece of carbon fiber fabric, and at least one panel;
applying an adhesive material on the core and the at least one panel;
assembling the core, the at least one piece of carbon fiber fabric, and the at least one panel, wherein each of the at least one piece of carbon fiber fabric is located between one of the at least one panel and the core, and the at least one panel and the core are firmly combined by the adhesive material; and
covering a plastic film on a surface of the at least one panel by extrusion.

10. The method of claim 9, further comprising a step of providing a fireproof layer either between the core and one of the at least one piece of carbon fiber fabric, or between one of the at least one carbon fiber fabric and one of the at least one panel while assembling the core, the at least one piece of carbon fiber fabric, and the at least one panel.

11. The method of claim 9, further comprising a step before providing the at least one piece of carbon fiber fabric, which provides a fireproof layer to be combined with one of the at least one piece of carbon fiber fabric, and places the fireproof layer either between the core and one of the at least one piece of carbon fiber fabric, or between one of the at least one carbon fiber fabric and one of the at least one panel while assembling the core, the at least one piece of carbon fiber fabric, and the at least one panel.

12. The method of claim 9, further comprising a step of processing the surface of the at least one panel after assembling the core, the at least one piece of carbon fiber fabric, and the at least one panel.

13. The method of claim 9, wherein the at least one panel includes a plurality of panels, wherein the plurality of panels are arranged along surfaces of the core to cover the core.

14. The method of claim 13, wherein the core has multiple side surfaces, and at least one of the side surfaces is wider than other of the side surfaces; the at least one piece of carbon fiber fabric is affixed on the wider side surface of the core.

15. The method of claim 13, wherein the at least one piece of carbon fiber fabric covers the surfaces of the core.
